(19) United States
(12) Patent Application Publication
(10) Pub. No.: US 2010/0133167 A1
(43) Pub. Date: Jun. 3, 2010

(54) Disposable Drain Filter

(76) Inventor: Nancy Collins, Hilton Head Island, SC (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 12/629,724

(22) Filed: Dec. 2, 2009

Related U.S. Application Data
(60) Provisional application No. 61/119,453, filed on Dec. 3, 2008.

(51) Int. Cl. B01D 35/28

(52) U.S. Cl. 210/447

(57) ABSTRACT

The present invention advantageously provides an inexpensive and disposable drain filter that includes a first annulus, a second annulus, a filter layer, secured between the first and second annuli, to filter particulates from a fluid, and an adhesive layer, disposed on the lower surface of the second annulus, to temporarily secure the second annulus to a surface exposed to the fluid. The filter layer may form a dome above the upper surface of the first annulus.

### CROSS-REFERENCE TO RELATED APPLICATIONS

This application claims priority of U.S. provisional patent application Ser. No. 61/119,453, filed Dec. 3, 2008, the disclosure of which is hereby incorporated by reference in its entirety.

### FIELD OF THE INVENTION

The present invention relates generally to filters. More particularly, the present invention relates to drain filters.

### BACKGROUND OF THE INVENTION

Materials, such as hair and soap scum, and other small particles, often clog up a drain and require the use of caustic chemicals or other methods to unclog. The use of caustic chemicals can be dangerous to one's health and the environment. Therefore, attempts have been made to address this issue by providing drainage filters or traps to collect these unwanted materials before they go down the drainage pipe.

However, these attempts suffer from many disadvantages, such as, for example, metal filters may cause rusting around the drain; metal filters, as well as filters made from other rigid materials, are inflexible and generate discomfort when stepped upon; the height of these filters allows water and soap scum to be collected around the perimeter or can allow hair, soap scum, and small particles to bypass the filter by slipping beneath the filter; these filters are expensive to manufacture; these filters are not disposable and therefore require the difficult and unpleasant cleaning task of removing hair, soap scum, etc., from the filter; as well as other disadvantages. Accordingly, an improved drain filter is needed.

### SUMMARY OF THE INVENTION

Embodiments of the present invention advantageously provide an inexpensive and disposable drain filter that includes a first annulus, a second annulus, a filter layer secured between the first and second annuli to filter particulates from a fluid, and an adhesive layer disposed on the lower surface of the second annulus to temporarily secure the second annulus to a surface exposed to the fluid. In other embodiments of the present invention, the filter layer forms a dome above the upper surface of the first annulus.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

Hereinafter the invention will be illustrated in detail by way of embodiments with reference to the drawings.

FIG. 1 is a perspective view of a drain filter, according to an embodiment of the present invention.

FIG. 2 is a bottom view of a drain filter, according to an embodiment of the present invention.

FIG. 3 is a side view of a drain filter, according to an embodiment of the present invention.

FIG. 4 is an exploded view of a drain filter, according to an embodiment of the present invention.

FIG. 5 is a perspective view of a drain strainer, according to another embodiment of the present invention.

FIG. 6 is a bottom view of a drain strainer, according to another embodiment of the present invention.

FIG. 7 is a side view of a drain strainer, according to another embodiment of the present invention.

FIG. 8 is an exploded view of a drain strainer, according to another embodiment of the present invention.

FIG. 9 is a perspective view of a drain strainer, according to a further embodiment of the present invention.

FIG. 10 is a bottom view of a drain strainer, according to a further embodiment of the present invention.

FIG. 11 is a side view of a drain strainer, according to a further embodiment of the present invention.

FIG. 12 is an exploded view of a drain strainer, according to a further embodiment of the present invention.

### DETAILED DESCRIPTION OF THE INVENTION

The invention will now be described with reference to the drawing figures, in which like reference numerals refer to like parts throughout. Generally, the terms “drain filter” and “drain strainer” refer to various embodiments of the present invention and are used interchangeably herein.

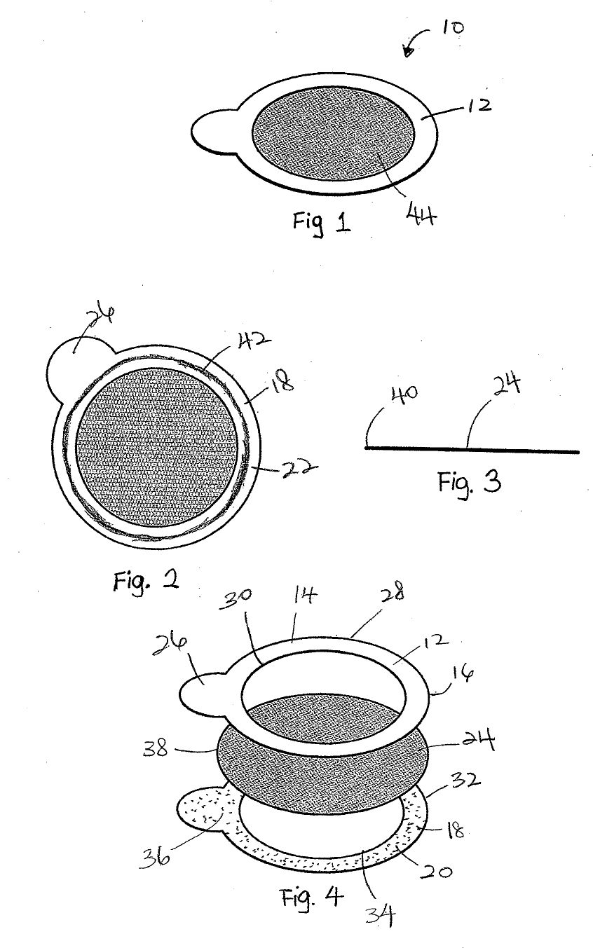

FIGS. 1, 2, 3 and 4 illustrate several views of a disposable drain filter according to an embodiment of the present invention, including perspective, bottom, side and exploded views, respectively. Disposable drain filter 10 includes a first annulus 12, a second annulus 18, and netting material that is disposed between the first annulus 12 and the second annulus 18 to form a filter layer 24. The first annulus 12 has an upper surface 14, a lower surface 16, an outer edge 28 and an inner edge 30. Similarly, the second annulus 18 has an upper surface 20, a lower surface 22, an outer edge 32, and an inner edge 34. Preferably, the first annulus 12 and the second annulus 18 are substantially similar in dimension.

In this embodiment, inner edge 30 and inner edge 34 define an inner hole 44 in which filter layer 24 is disposed. Preferably, the diameter of inner hole 44 is as large as, or larger than, the drain (not shown), which advantageously facilitates the flow of water through the filter layer 24 and into the drain. For example, for bathtubs or showers, the diameter of inner hole 44 may be about 2 inches to about 6 inches, preferably about 3.5 inches to about 4.5 inches. For laundry or utility sinks, floor drains, etc., the diameter of the inner hole 44 may be about 4 inches to 7 inches. Alternatively, the diameter of inner hole 44 may be less than the diameter of the drain hole, which may reduce the flow of water through the drain filter 10, thereby reducing, somewhat, the filtering effectiveness of drain filter 10.

An adhesive 42 is provided on lower surface 22 to allow drain filter 10 to be temporarily affixed to the floor of a shower stall, bathtub, sink, etc., i.e., any surface surrounding a drain. Adhesive 42 is preferably water insoluble so as to remain affixed to the surface surrounding the drain when exposed to water (or other fluid). The temporary nature of adhesive 42 advantageously allows for the easy removal of drain filter 10 for convenient disposal. The adhesive 42 also seals the edge of drain filter 10 to the surface surrounding the drain, thus preventing anything from slipping beneath the filter and entering the drain. A removable, thin protective film (not shown) may be used to cover adhesive 42 prior to installation.

The first annulus 12 and the second annulus 18 are preferably made of lightweight, soft, thin, non-woven material, such as, for example, polyester, nylon, rayon, polyamide, etc., or combination(s) thereof. In one embodiment, lower surface 16 and upper surface 20 may be coated with a heat sensitive material 36. During the assembly of this embodiment, filter layer 24 is first placed between first annulus 12 and second annulus 18, and then heat is applied to activate the heat sensitive material 36 to fuse these components together. One preferred non-woven fusible material is Pellon® Fusibles; other heat sensitive materials 36 are contemplated by the present invention. In alternative embodiments, first annulus 12 and second annulus 18 may be made from other types of materials, such as, for example, flexible plastic, latex, rubber membrane material, etc. In these embodiments, filter layer 24 may be affixed between the first annulus 12 and 18 using heat treatment, adhesives, etc.

Filter layer 24 can be made from many different materials, including nylon, silk, rayon, etc., and includes a very fine gauge, such as, for example, approximately one millimeter in diameter. Filter layer 24 has an outer edge 38 that defines the overall diameter that is at least slightly larger than the diameter defined by inner edge 30 and inner edge 34. In a preferred embodiment, filter layer 24 includes a single layer of filter material, while in alternative embodiments, filter layer 24 may include two or more individual layers of filter material.

Generally, the thickness of disposable drain filter 10 may be as thin as tissue paper, and, in one preferred embodiment, the thickness is about 0.04 inches. Advantageously, due to the thinness of drain filter 10, water will be able to flow freely down the drain without impediment, and dirty bathwater and soap scum would not be collected around the edge of the drain filter 10. Additionally, because the drain filter 10 is made of lightweight, soft, thin materials, drain filter 10 is comfortable to stand on. For example, for stand-up style showers, the drain outlet is often in the middle of stall and, when placed over the drain, the user will not experience undue discomfort if stepped upon.

In alternative embodiments of the present invention, drain filter 10 may include one or more tabs 26 formed on the outer edge of the first annulus 12, and/or one or more tabs 36 formed on the outer edge of the second annulus 18. Generally, tabs 26 and 36 may be of any shape or size, such as, for example, a semicircular shape, such that the user grasps and gently pulls drain filter 10 off the surface using tabs 26 and 36. The particulates trapped by drain filter 10 are then disposed of (along with drain filter 10). This easy removal and disposal of the particulates and the drain filter 10 obviates the difficult task of cleaning the filter. The disposable drain filter 10 may be used for several days, depending, of course, on the amount of debris collected. Preferably, tabs 26 and 36 are made from the same material as the first annulus 12 and the second annulus 18 and formed integrally therewith. Alternatively, tabs 26 and 36 may be made from a different material and attached to the outer surface of, or partially disposed between, the first annulus 12 and/or the second annulus 18.

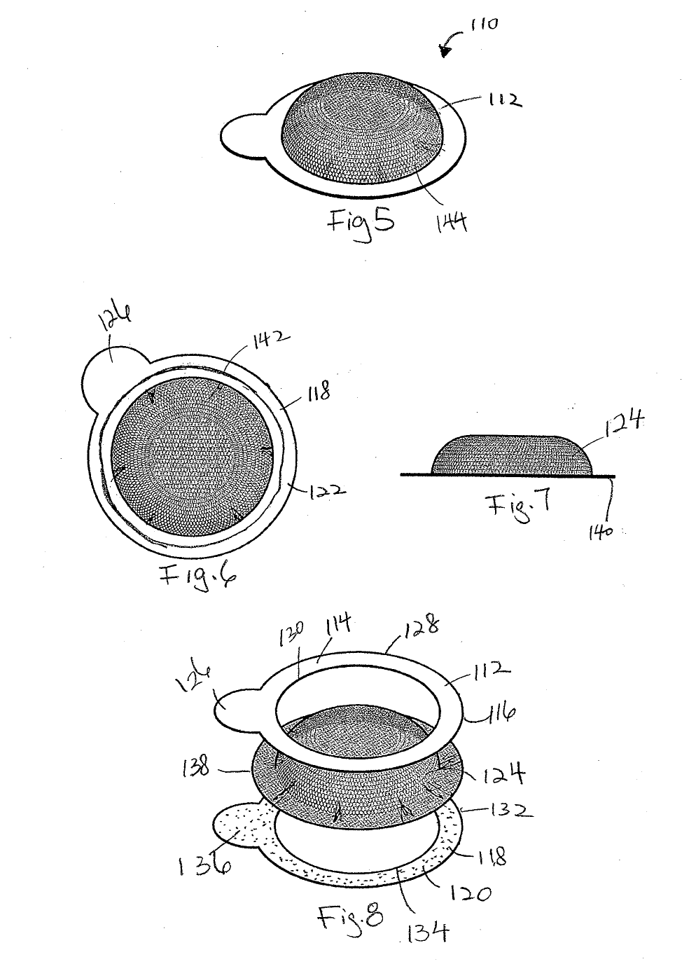

FIGS. 5, 6, 7 and 8 illustrate several views of a disposable drain strainer according to another embodiment of the present invention, including perspective, bottom, side and exploded views, respectively. Disposable strainer 110 includes a first annulus 112, a second annulus 118, and a filter layer 124, disposed between the first annulus 112 and the second annulus 118, that forms a dome. The first annulus 112 has an upper surface 114, a lower surface 116, an outer edge 128 and an inner edge 130. Similarly, the second annulus 118 has an upper surface 120, a lower surface 122, an outer edge 132, and an inner edge 134. Preferably, the first annulus 112 and the second annulus 118 are substantially similar in dimension.

Filter layer 124 has a particular height to accommodate drains that include protruding structure, such as, for example, drain covers often found in bathtubs that are opened and closed either by twisting the drain cover itself or by means of a lever above the drain. Unlike prior drain strainers, this embodiment of the inventive drain strainer 110 advantageously allows a user to place it over the drain opening and drain cover without removal of the stopper, plug, or any parts of the drain system. During use, hair, soap scum, and particles are collected on the filter layer 124 and water freely flows down the drain. Since the adhesive of the lower surface of the second annulus is water insoluble, a user can place the drain strainer 110 over the drain hole and enjoy a bath, without having to remove the drain filter 10 to permit the opening or closing of the drain. In one embodiment, the height of the domed filter layer 124 is approximately one inch.

Advantageously, because filter layer 124 is flexible, the user can turn the domed filter layer 124 inside out. By doing so, the user can use it as a collection basket for debris if the user removes the stopper or plug from the bath tub or sink. Thus, instead of having debris on the outside of the dome 14, the debris would be collected inside the dome 14.

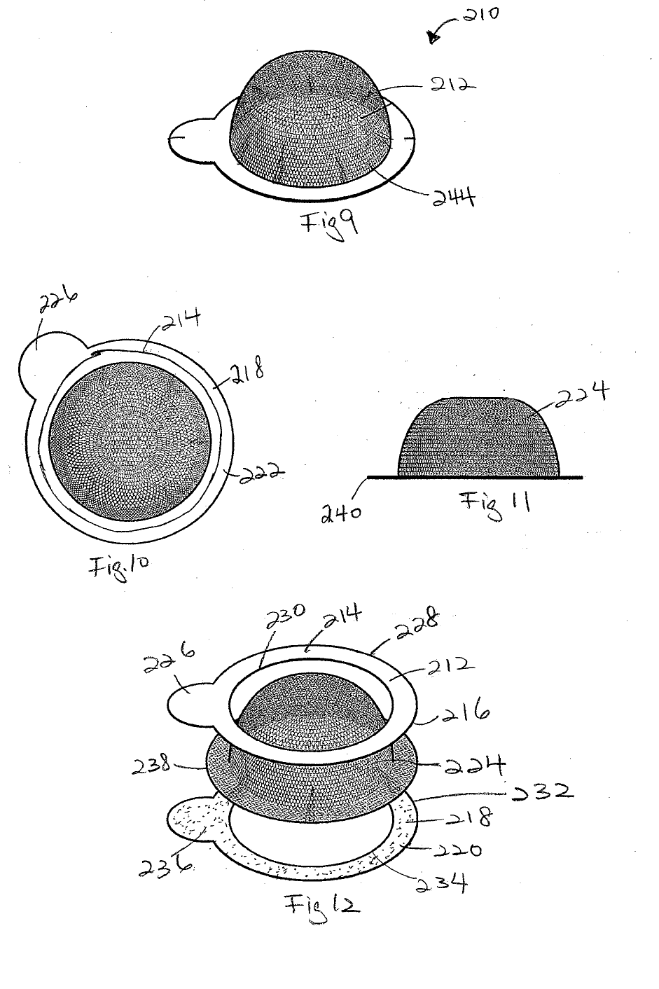

FIGS. 9, 10, 11 and 12 illustrate several views of a disposable drain filter according to a further embodiment of the present invention, including perspective, bottom, side and exploded views, respectively. Disposable strainer 210 includes a first annulus 212, a second annulus 218, and a filter layer 224 disposed between the first annulus 212 and the second annulus 218 that forms a dome, similar to the previous embodiment but greater in height. The first annulus 212 has an upper surface 214, a lower surface 216, an outer edge 228 and an inner edge 230. Similarly, the second annulus 218 has an upper surface 220, a lower surface 222, an outer edge 232, and an inner edge 234. Preferably, the first annulus 212 and the second annulus 218 are substantially similar in dimension.

Advantageously, due to the increased height of domed filter layer 224, the drain cover can be manipulated without removing the strainer. Additionally, due to the height of domed filter layer 224, drain strainer 210 can collect additional debris and can be used longer in the bathtub. In one embodiment, the height of the domed filter layer 224 is approximately 2 inches.

Generally, embodiments of the present invention may be manufactured by hand as well as by automated processes.

In an exemplary embodiment, two squares of fusible lightweight fabric are first cut, and then an inner circle of material is removed from the center of each square. For example, the squares may be 5 inches by 5 inches, while the inner circle may have a diameter of 3.5 inches (or other diameter substantially suitable for a drain). Next, a 5 inch square (or circle) of netting material, sometimes known as “tulle”, is cut, and placed between the two fusible lightweight fabric pieces, with the fusible side (i.e. heat-sensitive material side) touching the netting material. Then, steam heat and pressure is applied to the square pieces of fabric, thereby fusing the two fabric squares to the netting material and to each other. In this embodiment, the netting material will conform to a flat height profile. Next, the outer edge of the assembled piece is cut to a circular shape, including optional tabs. A liquid temporary-bond adhesive is applied to the bottom of the assembled piece, and, after the adhesive is dried, a removable, thin protective film is applied to the temporary adhesive.

In another exemplary embodiment, two squares of fusible lightweight fabric are first cut, and then an inner circle of material is removed from the center of each square. For example, the squares may be 5 inches by 5 inches, while the inner circle may have a diameter of about 4 inches (or other diameter substantially suitable for a drain). Next, a 7 inch square (or circle) of netting material is cut, and placed between the two fusible lightweight fabric pieces, with the fusible side (i.e. heat-sensitive material side) touching the netting material. Then, steam heat and pressure is applied to the square pieces of fabric, thereby fusing the two fabric squares to the netting material and to each other. In this embodiment, the netting material will conform to a domed height profile. Next, the outer edge of the assembled piece is cut to a circular shape, including optional tabs. A liquid temporary-bond adhesive is applied to the bottom of the assembled piece, and, after the adhesive is dried, a removable, thin protective film is applied to the temporary adhesive. Various dome heights may be formed based upon the amount of netting material employed.

The many features and advantages of the invention are apparent from the detailed specification, and, thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and, accordingly, all suitable modifications and equivalents may be resorted to that fall within the scope of the invention.

What is claimed is:

1. A disposable drain filter, comprising:
a first annulus having an upper surface, a lower surface, an inner edge and an outer edge;
a second annulus having an upper surface, a lower surface, an inner edge and an outer edge;
a filter layer, secured between the lower surface of the first annulus and the upper surface of the second annulus, to filter particulates from a fluid; and
an adhesive layer, disposed on the lower surface of the second annulus, to temporarily secure the second annulus to a surface exposed to the fluid.

2. The disposable drain filter of claim 1, wherein the inner edge of the first annulus and the inner edge of the second annulus are about 3.5 inches to 4.5 inches.

3. The disposable drain filter of claim 1, further comprising heat-sensitive fusing material disposed on at least one of the lower surface of the first annulus and the upper surface of the second annulus.

4. The disposable drain filter of claim 3, wherein the heat-sensitive fusing material secures the filter layer between the first and second annuli.

5. The disposable drain filter of claim 4, wherein a portion of the filter layer is fused between the first and second annuli.

6. The disposable drain filter of claim 1, wherein the first and the second annuli are non-woven, soft, flexible materials having a thickness of about 0.04″ in thickness.

7. The disposable drain filter of claim 1, further comprising at least one tab disposed along the outer edge of at least one of the first and the second annuli.

8. The disposable drain filter of claim 1, wherein the filter layer has an average hole diameter of approximately 1 mm.

9. The disposable drain filter of claim 1, further comprising a removable, thin protective film disposed over the adhesive layer.

10. The disposable drain filter of claim 1, wherein the filter layer includes a plurality of individual filter layers.

11. A disposable drain strainer, comprising:
a first annulus having an upper surface, a lower surface, an inner edge and an outer edge;
a second annulus having an upper surface, a lower surface, an inner edge and an outer edge;
a filter layer, fused between the lower surface of the first annulus and the upper surface of the second annulus, to filter particulates from a fluid, the filter layer forming a dome having a predetermined height above the upper surface of the first annulus;
an adhesive layer, disposed on the lower surface of the second annulus, to temporarily secure the second annulus to a surface exposed to the fluid; and
a removable, thin protective film disposed over the adhesive layer.

12. The disposable drain strainer of claim 11, wherein the inner edge of the first annulus and the inner edge of the second annulus are about 4 inches.

13. The disposable drain strainer of claim 11, wherein the first and the second annuli are non-woven, soft, flexible materials having a thickness of about 0.04″ in thickness.

14. The disposable drain strainer of claim 11, further comprising at least one tab disposed along the outer edge of at least one of the first and the second annuli.

15. The disposable drain strainer of claim 11, wherein the filter layer has an average hole diameter of approximately 1 mm.

16. The disposable drain strainer of claim 15, wherein the predetermined height is about 2 inches.

17. The disposable drain strainer of claim 11, wherein the filter layer includes a plurality of individual filter layers.
